(19) United States
(12) Patent Application Publication
(10) Pub. No.: US 2016/0236374 A1
(43) Pub. Date: Aug. 18, 2016

(54) PACKERHEAD MACHINE

(71) Applicant: Hawkeye Concrete Products Co., Mediapolis, IA (US)

(72) Inventor: Claudio SUBACCHI, Mediapolis, IA (US)

(21) Appl. No.: 14/995,878

(22) Filed: Jan. 14, 2016

Related U.S. Application Data
(60) Provisional application No. 62/117,529, filed on Feb. 18, 2015.

(51) Int. Cl. B28B 21/26; B28B 21/14; B28B 21/24; B28B 21/18

(52) U.S. Cl. CPC B28B 21/26; B28B 21/18; B28B 21/14; B28B 21/247

(57) ABSTRACT

A bell packer comprises of a rotating member combinable to a pallet for rotating the pallet, a vibrator for providing oscillatory motion, and a vibrating member engaged with the vibrator positioned apart from the rotating member for vibrating the pallet. A hopper for storing concrete slurry has an opening to a first auger and a second auger that convey the concrete slurry toward the shaft so that the concrete slurry falls to the center of a mold. A drive assembly comprises of a pair of motors configured for counter-rotation of a pair of concentric shafts with each having a gear and pulley linked by a belt wherein the pulleys are concentric with each other and the counter-rotating shafts.

This application claims priority to U.S. Provisional Application 62/117,529 filed on Feb. 18, 2015 the contents of which are hereby incorporated by reference herein.

### BACKGROUND

This disclosure relates to a packerhead machine, and more particularly, this disclosure relates to a twin feed auger, a cross head transmission and a bell packer.

In the packerhead system of concrete pipe manufacture a packerhead which consists of a rollerhead, or roller assembly, and a trowel, more frequently referred to as a longbottom, are lowered into a circular mold and rotated as they move upwardly, all the while packing wet concrete, which is dropped onto the packerhead, against the inner wall surface of the mold.

Concrete pipe products typically have a tongue or male end and a socket or female end which is bell-shaped. Either end of the pipe product may be adapted to receive a gasket (e.g. rubber or other suitable material) for creating a water-tight seal between sections of the pipe when joined. The surface texture and finish of the inner socket end (the surface formed by the upper vertical and horizontal surfaces of the curing pallet) must be adequately compacted to provide the compressive and tensile strength required to resist the force applied by forcing the gasketed end or ends in place. It also is important that the inner concrete surface of the socket end be smooth and void-free to facilitate a water-tight seal. One or both of these two critical conditions frequently are not attained due, principally to the failure of the machinery to provide effective vibration during the pipe-forming process.

The application of vibration to the cement slurry causes the mixture to assume a more fluid state during the vibration action, so that following the vibration procedure, the resulting vibrating product is in a more consolidated or dense state. Vibration additionally results in the finest components of the slurry being moved to the molded surfaces, thus achieving the desired surface texture. The effectiveness and efficiency of the vibrating action are dependent upon its application directly to the concrete mixture or to the mixture through a mold or machine component, in the frequency, impact, and amplitude appropriate for achieving the desired result.

### SUMMARY

A bell packer for a packerhead machine is disclosed. The bell packer comprises of a rotating member combinable to a pallet for rotating the pallet, a vibrator for providing oscillatory motion, and a vibrating member engaged with the vibrator positioned apart from the rotating member for vibrating the pallet. In this regard, the rotating member is substantially isolated from vibration from the vibrating member. In one implementation, the vibrating member and the rotating member are concentrically aligned. The bell packer can further comprise of a support structure assembly for supporting a pair of vibrators to vibrate the pallet in a vertical oscillatory motion.

The support structure assembly can comprise of a pallet support structure combined to the vibrating member and mounted above a support structure. At least one opening is provided in the pallet support structure that leads to a funnel concentric with the vibrating member that receives and directs excess slurry downward.

A drive mechanism is provided for rotating the rotating member. The drive mechanism is mounted to a first frame that is engaged for movement along a second frame. The bell packer can be configured to rotate the pallet simultaneous with vibrating the pallet.

In another implementation, a packerhead machine can be configured with a hopper for storing concrete slurry. An opening in the hoper leads to a first auger and a second auger that convey the concrete slurry toward the shaft so that the concrete slurry falls to the center of a mold.

The first auger and the second auger can be contained in a shell. A pair of motors for driving the first auger and the second auger is combined to the outside of the shell. The other end of the shell contains a pair of bearings for supporting the other ends of the first auger and the second auger, respectively. The hopper and the shell is configured to move with the drive mechanism for the packerhead while the first auger and the second auger convey concrete slurry at a substantially constant feed rate to a position concentric with the shaft.

In another implementation, a drive assembly for the packerhead machine is provided. The drive assembly comprises of a pair of motors that engage a corresponding pair of transmissions, which can be configured for counter-rotation of a pair of concentric shafts. Each transmission can comprise of a gear and pulley linked by a belt wherein the pulleys are concentric with each other and the counter-rotating shafts.

The above and other objects, features, and advantages will become more readily apparent from the following, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

### BRIEF DESCRIPTION OF THE ILLUSTRATED EMBODIMENTS

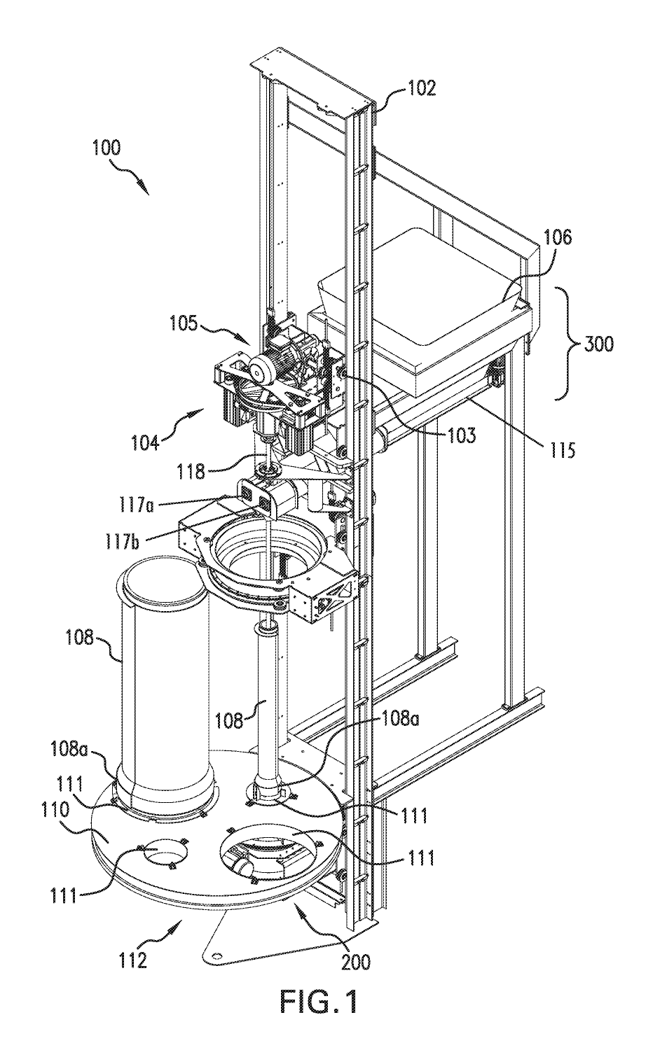

FIG. 1 is a perspective view of a concrete pipe forming apparatus, which has been adapted with the present invention.

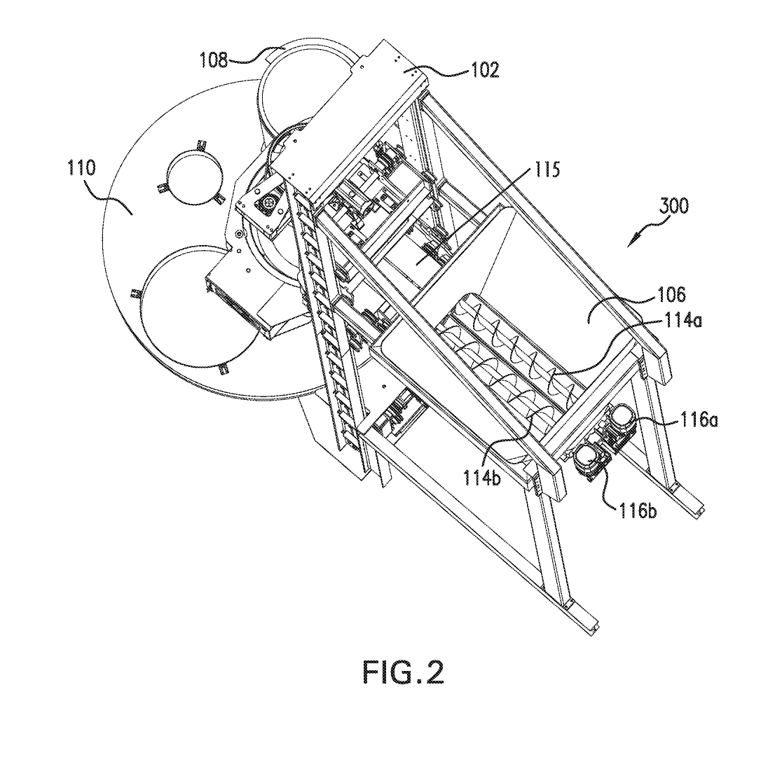

FIG. 2 is a top-perspective view of the concrete pipe forming apparatus of FIG. 1.

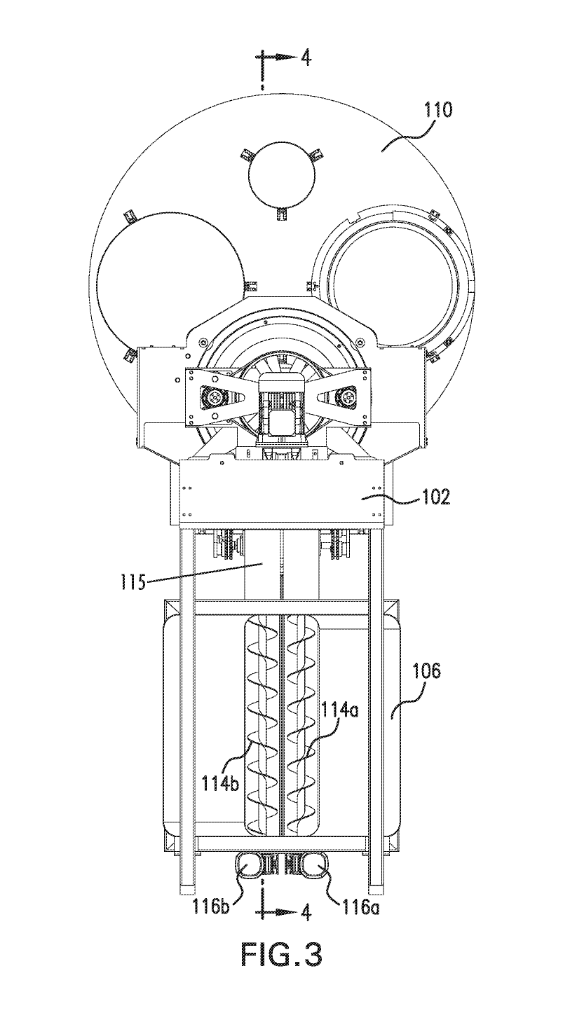

FIG. 3 is a top-plan view of the concrete pipe forming apparatus of FIG. 1.

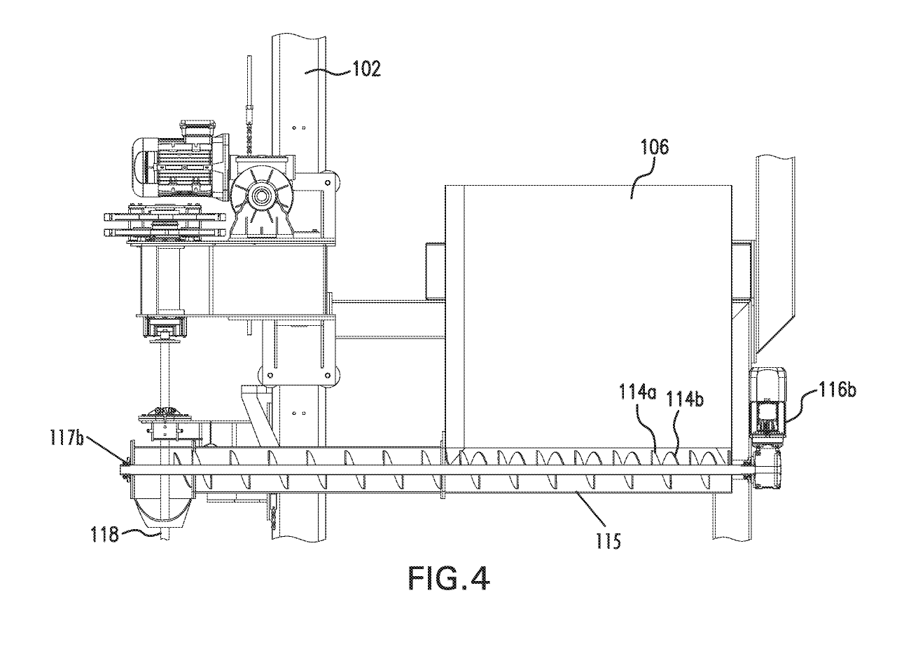

FIG. 4 is a side view of the concrete pipe forming apparatus of FIG. 1.

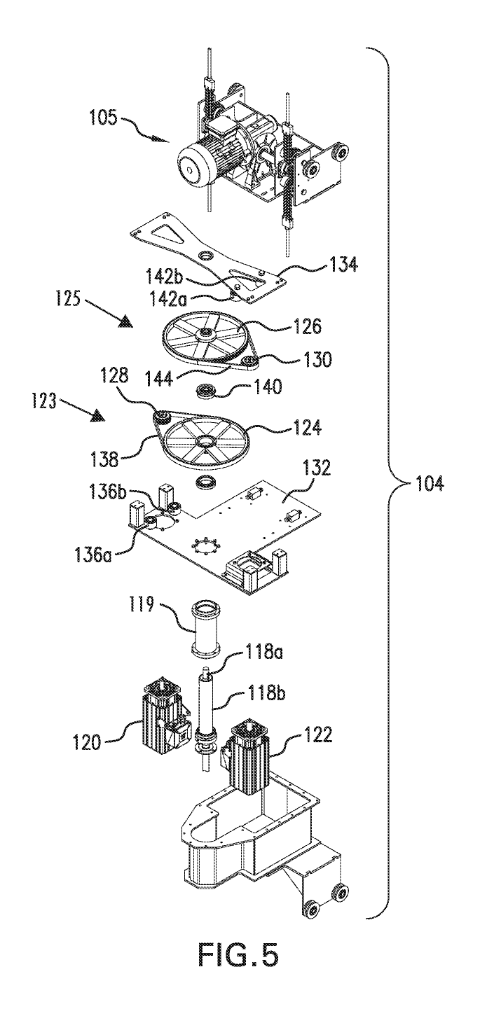

FIG. 5 is an exploded view of a crosshead transmission for counter-rotating the main shafts.

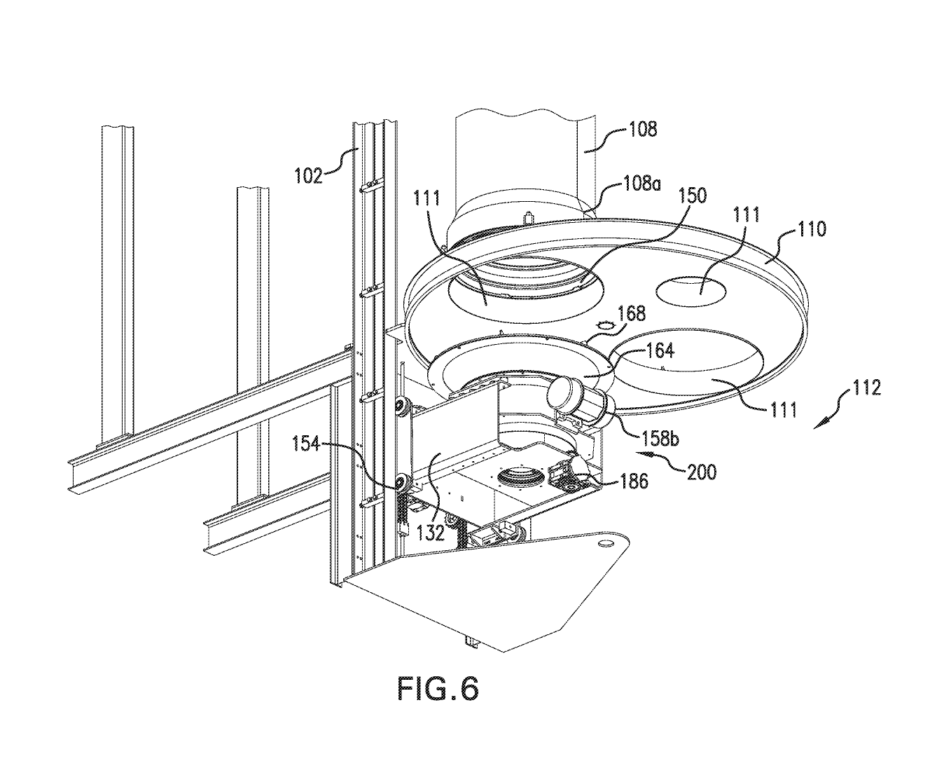

FIG. 6 is a perspective view of a bell packer.

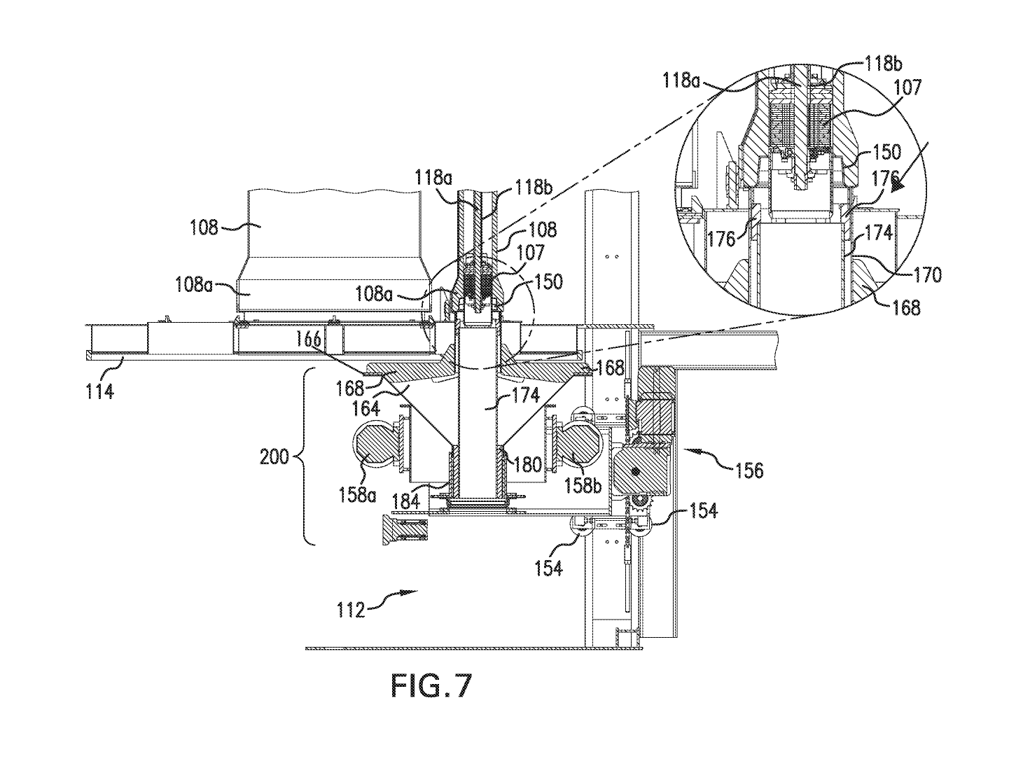

FIG. 7 is a side view of the bell packer of FIG. 6.

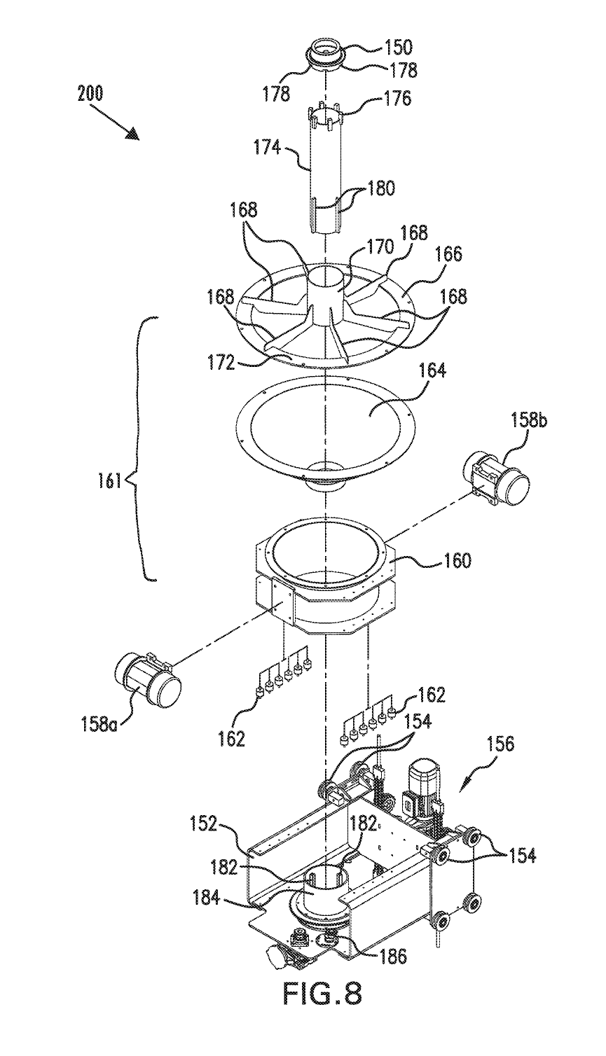

FIG. 8 is an exploded view of the bell packer of FIG. 6.

### DETAILED DESCRIPTION OF THE INVENTION

FIG. 1 shows a concrete pipe forming apparatus also known as a packerhead machine 100. Generally, packerhead machine 100 has a frame 102 to bear the weight of a drive assembly 104. Drive assembly 104 is mounted on roller guides 103 and moved by a guide mechanism 105 that moves drive assembly 104 upward and downward along frame 102. Roller guides 103 that connect drive assembly 104 to frame 102 position drive assembly 104 with respect to frame 102 permit drive assembly 104 to move quickly and smoothly about frame 102.

Drive assembly 104 powers a roller head 107 (see FIG. 7), which is a circular powered series of compacting rollers that compact concrete slurry and a trowel utilized in concrete pipe formation driven by a shaft 118.

Concrete slurry is fed into a mold 108 by a twin auger system 300. FIGS. 2-4 show twin auger system 300, which includes hopper 106 for receiving and holding concrete slurry. A shell 115 is positioned beneath the opening underneath hopper 106. Shell 115 contains a first auger 114a and a second auger 114b that are driven by a pair of motors 116a, 116b, respectively, that are mounted to shell 115. First auger 114a and second auger 114b are positioned underneath the open, bottom end of hopper 106 to convey slurry from hopper 106 to the center of shaft 118 where it flows into mold 108 as drive assembly 104 rotates and draws roller head 107 upward, packing and smoothing the concrete slurry against mold 108 in the process. The other ends of first auger 114a and second auger 114b are supported at the other end of shell 115 by a first bearing 117a and a second bearing 117b, respectively.

First auger 114a and second auger 114b are positioned on either side of shaft 118 so that slurry is conveyed and deposited concentric with shaft 118. This position allows concrete slurry to be delivered at a constant feed rate to the center of shaft 118 where it can be uniformly applied around the circumference of the mold. First auger 114a and second auger 114b can remain in a fixed position without ever having to be moved or adjusted based on the feed rate of first auger 114a and second auger 114b as the concrete slurry will always be deposited concentric with shaft 118. As compared to a belt conveyor system, first auger 114a and second auger 114b are a more precise conveyor which allows hopper 106 to be enlarged for more holding capacity since first auger 114a and second auger 114b convey a fixed amount of material based on their design.

Drive assembly 104 can have a crosshead transmission, as shown in FIG. 5. A first motor 120 and a second motor 122 drive a first transmission 123 and a second transmission 125, respectively. First transmission 123 comprises of a first pulley 124 and a first gear 128. Second transmission 125 comprises of a second pulley 126 and a second gear 130. Respective first pulley 124 and second pulley 126 are used to drive shaft 118 which can be a pair of concentric shafts 118a and 118b to drive a counter-rotating roller head and long bottom, as described in U.S. Pat. No. 7,125,239, titled Concrete Pipe Manufacturing Machinery and Methods, the contents of which are hereby incorporated herein by reference. Drive shaft 118a is driven by pulley 126 and drive shaft 118b is driven by pulley 124. Pulleys 124 and 126 are positioned between a bottom plate 132 and a top plate 134. First gear 128 is positioned between a pair of rollers 136a, 136b that hold a toothed belt 138 in position on first gear 128. Second pulley 126 is concentric with first pulley 124 and separated by a spacer 140. Second gear 130 is positioned between a pair of rollers 142a, 142b combined to top plate 134 that hold a toothed belt 144 in position on second gear 130.

Drive assembly 104 with a crosshead transmission uses toothed belts 138 and 144 which are much cheaper than a gear box found in prior art devices. Maintenance of drive assembly 104 is also easier as only the roller bearings need lubricated. Finally, the counter-rotating pulleys self-cancel the pretension load of belts 138 and 144 on shafts 118a and 118b. A hub 119 surrounds the outer shaft bearings.

First transmission 123 and second transmission 125 can comprise of a chain driven pulley system or a timing belt.

FIG. 6 shows an indexing table 110 that supports mold 108 above a pit 112. Indexing table 110 has one or more circular rings 111 to receive molds 108. Mold 108 is positioned on the edge of circular ring 111 so that the inner area of circular ring 111 is in line with the inside of mold 108. A bell packer 200 is located in pit 112 and fitted with a pallet 150 that is raised into the inside of mold 108, so that pallet 150 is positioned in a bell portion 108a of mold 108. Pallet 150 is used for forming the end of a concrete pipe and transporting the concrete pipe during the manufacture and curing processes. Packerhead machine 100 fills and packs mold 108 with concrete slurry. While mold 108 is being used, another mold 108 can be positioned on the empty circular ring 111, so that when the first mold 108 is filled it can be quickly exchanged with the empty mold 108.

More specifically, bell packer 200 rotates and vibrates pallet 150 and mold 108 so that the concrete slurry fills the entirety of bell portion 108a of mold 108 and compacts as it settles. FIG. 8 shows bell packer 200. Bell packer 200 includes a frame 152 mounted by rollers 154 to frame 102 and engaged for movement so it can be moved up and down on frame 102 by a motor drive assembly 156. A pair of vibrators 158a and 158b are mounted to opposite sides of a support structure assembly 161 that includes a support structure 160. Vibrators 158a, 158b cause a vertical oscillatory motion which is imparted to bell portion 108a of mold 108. Support structure 160 is separated from frame 152 by shock absorber 162, which can be a plurality of bushings to dampen oscillatory movement in frame 152. A funnel 164 is combined to the top side of support structure 160 the purpose of which is discussed more thoroughly below.

Support structure assembly 161 also includes a pallet support structure 166 that is positioned on top of funnel 164. Pallet support structure 166 supports pallet 150 and imparts vertical vibratory oscillation from vibrators 158a and 158b to pallet 150. Pallet support structure 166 includes a plurality of members 168 that connect a vibrating member 170, which looks like a tube in the illustrated embodiment, to outer circumference 172 of pallet support structure 166. The opening between members 168 allows excess concrete slurry to flow into funnel 164 and into pit 112 (as shown in FIG. 7). At least one opening is need but as many openings as possible between members 168 while allowing pallet support member 166 to support vibrating member 170 and pallet 150 is preferred.

A rotating member 174, which looks like a tube in the illustrated embodiment, is positioned concentrically inside vibrating member 170 on pallet support structure 166. Rotating member 174 has a plurality of members 176 that engage corresponding notches 178 in pallet 150. On the opposite end of rotating member 174 is a plurality of members 180 that slide into corresponding notches 182 in a receiving tube 184 mounted to frame 152. A drive mechanism which includes a motor 186 rotates receiving tube 184, and thus pallet 150 during the concrete pipe forming process in order to pack the concrete slurry inside bell portion 108a of mold 108.

FIG. 7 shows a close up view of bell packer 200 engaged with mold 108. Notches 178 of rotating member 174 are engaged in corresponding notches 178 of pallet 150, so pallet 150 can be rotated. Vibrating member 170 combined to pallet support structure 166 engage and press up against the bottom side of pallet 150. Vibration in the form of vertical motion or vertical oscillation from vibrators 158a and 158b is translated to pallet support structure 166 through vibrating member 170 to pallet 150.

Vibration of mold 108 is isolated from the rotation of mold 108. Vibration from vibrators 158a and 158b is transmitted through pallet support structure 166 to bell portion 108a of mold 108. Mold 108 is rotated by rotating member 174 which is separated and isolated from the vibration. By separating the vibration from the rotation there is no need for an expensive bearing assembly to counter the forces from a vibrating mass.

While the present invention has been particularly shown and described with reference to exemplary embodiments thereof, it should be understood by those of ordinary skill in the art that various changes, substitutions and alterations can be made herein without departing from the scope of the invention as defined by appended claims and their equivalents.

What is claimed is:

1. A bell packer for a packerhead machine, the bell packer comprising:
a rotating member combinable to a pallet for rotating the pallet;
a vibrator for providing oscillatory motion; and
a vibrating member engaged with the vibrator positioned apart from the rotating member for vibrating the pallet, such that rotating member is substantially isolated from vibration from the vibrating member.

2. The bell packer of claim 1, wherein the rotating member and the vibrating member are concentrically aligned.

3. The bell packer of claim 2, and further comprising a support structure assembly combined to the vibrating member and having combined thereto on opposing sides a pair of vibrators for vibrating the pallet in a vertical oscillatory motion.

4. The bell packer of claim 3, wherein the support structure assembly further comprises a pallet support structure combined to the vibrating member and mounted above a support structure, wherein the pallet support structure includes at least one opening.

5. The bell packer of claim 4, wherein the support structure has combined thereto on opposing sides the pair of vibrators.

6. The bell packer of claim 1, and further comprising a funnel beneath at least one opening in a pallet support structure for receiving and directing excess concrete slurry.

7. The bell packer of claim 6, wherein the funnel is concentric with the vibrating member.

8. The bell packer of claim 1, and further comprising a drive mechanism combined to the rotating member for rotating the rotating member.

9. The bell packer of claim 8, and further comprising a first frame for supporting the bell packer, the first frame being engaged for movement along a second frame, the first frame having the drive mechanism for rotating the rotating member.

10. The bell packer of claim 9, and further comprising
a support structure assembly combined to the vibrating member and having combined thereto on opposing sides a pair of vibrators for vibrating the pallet in a vertical oscillatory motion;
a shock absorber positioned between the support structure assembly and the first frame to reduce vibration of the first frame; and
wherein bell packer is movable along the second frame and the bell packer is configured to rotate the pallet simultaneous with vibrating the pallet;
wherein the support structure assembly further comprises a pallet support structure combined to the vibrating member and mounted above a support structure, wherein the pallet support structure includes at least one opening, and a funnel beneath the at least one opening in the pallet support structure for receiving and directing excess concrete slurry beneath the first frame, wherein the funnel is concentric with the vibrating member and the rotating member.

11. A packerhead machine with a drive mechanism for rotating a shaft with a plurality of compacting rollers that compact concrete slurry in a mold, the packerhead machine comprising:
a hopper for storing concrete slurry with an opening underneath;
a first auger positioned on one side of the opening underneath the hopper and a second auger positioned on the other side of the opening underneath the hopper, the first auger and the second auger extending longitudinally to the shaft to deliver concrete slurry from the hopper to the shaft so that the concrete slurry falls into the mold.

12. The packerhead machine of claim 11, and further comprising a shell under the opening beneath the hopper for containing the first auger and the second auger.

13. The packerhead machine of claim 12, and further comprising at least one motor combined to the shell for driving the first auger and the second auger.

14. The packerhead machine of claim 13, and further comprising a first motor for driving the first auger and a second motor for driving the second auger.

15. The packerhead machine of claim 14, and further comprising a first bearing at an end of the shell opposite the first motor for supporting the first auger and a second bearing at the end of the shell opposite the second motor for supporting the second auger.

16. The packerhead machine of claim 14, wherein the hopper and the shell is configured to move with the drive mechanism about a frame while the first auger and the second auger convey concrete slurry at a substantially constant feed rate to a position concentric with the shaft.

17. A drive assembly for driving a counter-rotating roller head and long bottom for a packerhead machine, the drive assembly comprising:
a first motor;
a second motor;
a first transmission engaged with the first motor;
a second transmission engaged with the second motor;
a first shaft engaged with the first transmission for rotating one of the roller head and the long bottom in a first direction; and
a second shaft concentric with the first shaft for rotating the other of the roller head and the long bottom in a second direction.

18. The drive assembly of claim 17, wherein the first transmission further comprises a first gear engaged with the first motor and a first pulley engaged with the first gear by a first belt, and wherein the second transmission further comprises a second gear engaged with the second motor and a second pulley engaged with the second gear by a second belt.

19. The drive assembly of claim 18, wherein the first pulley is concentric with the second pulley.

20. The drive assembly of claim 19, and further comprising:
a bottom plate attached to the first motor beneath the first gear;
a first pair rollers combined to the bottom plate to position the first belt on the first gear;
a first spacer positioned between the bottom plate and concentric with the first pulley to position the first pulley above the bottom plate;
a second spacer positioned above the first pulley beneath the second pulley and concentric with the first pulley and the second pulley;
a top plate positioned above the second pulley; and
a second pair of rollers combined to the top plate to position the second belt on the second gear.
